(19) United States
(12) Patent Application Publication
(10) Pub. No.: US 2007/0105540 A1
(43) Pub. Date: May 10, 2007

(54) Portable electronic device to detect wireless signals in a shutdown state and the detection method

(75) Inventors: Jen-Huan Yu, Taipei (TW); Hsiang-Chang Lin, Taipei (TW)

Correspondence Address: BACON & THOMAS, PLLC, 625 SLATERS LANE, FOURTH FLOOR, ALEXANDRIA, VA, 22314, US

(73) Assignee: COMPAL ELECTRONICS, INC., Taipei (TW)

(21) Appl. No.: 11/333,274

(22) Filed: Jan. 18, 2006

(30) Foreign Application Priority Data
Nov. 8, 2005 (TW) 094139183

(51) Int. Cl. H04M 3/00

(52) U.S. Cl. 455/418

(57) ABSTRACT

A portable electronic device to detect wireless signals in a shutdown state comprises a motherboard module with an internally embedded controller (EC) and a display module with a wireless signal detector, when in a shutdown state, the portable electronic device activates the wireless signal detector via the embedded controller and when the wireless signal detector detects a wireless signal, the portable electronic device boots and links to a wireless local area network automatically via the firmware of the embedded controller; which embedded controller also controls an indication lamp to give a prompt of booting the device and linking to the wireless local area network manually. The portable electronic device ensures time and energy saving with extended service life by avoiding repeated booting and shutdown of the device.

### BACKGROUND OF THE PRESENT INVENTION

1. Field of the Invention

The present invention related generally to a portable electronic device, and more particularly to a portable electronic device that is capable of detecting wireless signals in a shutdown state.

2. Description of the Prior Art

With the rapid development of wireless transmission technology, more and more portable electronic devices, such as notebook (NB) and personal digital assistant (PDA), are designed with transmission and receiving interfaces for wireless communications. These portable electronic devices are capable of accessing to the Internet and executing automatic links within the transmission range of a wireless local area network (WLAN).

Currently, however, no commercial portable electronic devices capable of connecting to a network wirelessly can detect wireless signals in a shutdown state. These portable electronic devices are not capable of executing network detection for linking to a wireless local area network until they are booted and successfully initialized, no matter whether the location of the detection is inside or outside the transmission range.

Especially, when a user needs to execute wireless networking with a portable electronic device and no signal of network connection is detected because the location of the detection is outside the transmission range of the wireless local area network, the user must shut down the device, move to another place, and boot the device again for detection of the network connection. Thus, it takes more time and power for the user to successfully detect network connection signals with commercial portable electronic devices.

### SUMMARY OF THE INVENTION

The primary objective of the present invention is to provide a portable electronic device that is capable of detecting wireless signals in a shutdown state. Especially, the portable electronic device of the present invention is capable of pre-executing wireless signals in a shutdown state without the need of repeatedly booting the device and, thus conserving time and power and extending the life of the battery.

The portable electronic device of the present invention comprises a motherboard module with an internally embedded controller (EC) and a display module with a wireless signal detector. The input/output of the wireless signal detector and the embedded controller is electrically connected. Thereby the portable electronic device activates the wireless signal detector in a shutdown state and gives a wireless network prompt via the embedded controller when the wireless signal detector detects a wireless signal.

When detecting a wireless signal in a shutdown state, the portable electronic device will boot via the firmware of the embedded controller and link to the wireless local area network automatically or give the user a prompt of booting the device and linking to a wireless local area network manually. The detection method comprises the following steps:
(a) An input signal is generated to the embedded controller;
(b) The embedded controller follows the input signal of Step (a) to activate the detector and start detecting wireless signals;
(c) Checking whether a wireless signal is detected; if yes, executing Step (d); and
(d) The portable electronic device boots and links to a wireless local area network automatically; or an indication lamp lights up to indicate that the user can boot the device and link to the wireless local area network manually.

### BRIEF DESCRIPTION OF THE DRAWINGS

FIG. 1 shows a structural diagram of a portable electronic device that can detect wireless signals in a shutdown state;

FIG. 2 shows a configuration diagram of main components that the portable electronic device in FIG. 1 uses to detect wireless signals in a shutdown state;

FIG. 3 shows a flow chart of a detection method that a portable electronic device of the present invention uses to detect wireless signals in a shutdown state; it indicates that the portable electronic device of the present invention is capable of booting the device and linking to a wireless local area network automatically upon detection of a wireless signal; and

FIG. 4 shows another flow chart of the detection method that a portable electronic device of the present invention uses to detect wireless signals in a shutdown state; it indicates that an indication lamp gives the user a prompt for booting the device and linking to a wireless local area network manually upon detection of a wireless signal.

### DETAILED DESCRIPTION OF THE INVENTION

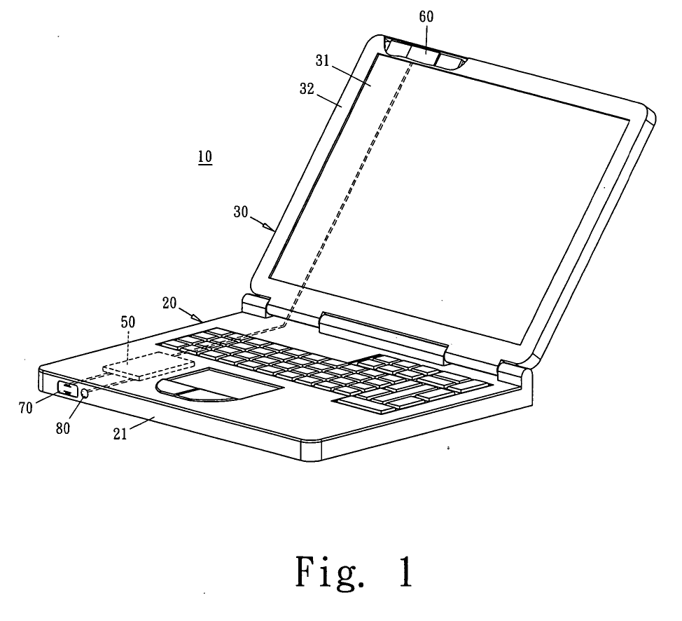

As FIG. 1 shows, the portable electronic device 10 of the present invention is capable of detecting wireless signals in a shutdown state within the transmission range in a wireless local area network. When detecting a wireless signal, the portable electronic device 10 gives a prompt of networking wirelessly or boots the device and links to the wireless local area network automatically.

The portable electronic device 10 is comprised of a motherboard module 20 and a display module 30. The motherboard module 20 has one each an internally disposed conventional motherboard and an embedded controller (EC) 50. A wireless signal detection button 70 and/or an indication lamp 80 are disposed on a side 21 of the motherboard module 20. The display module 30 is comprised of a display panel 31 and a casing 32 of the display panel 31. A space between the display panel 31 and the casing 32 of the display module 30 is reserved for installation of a wireless signal detector 60.

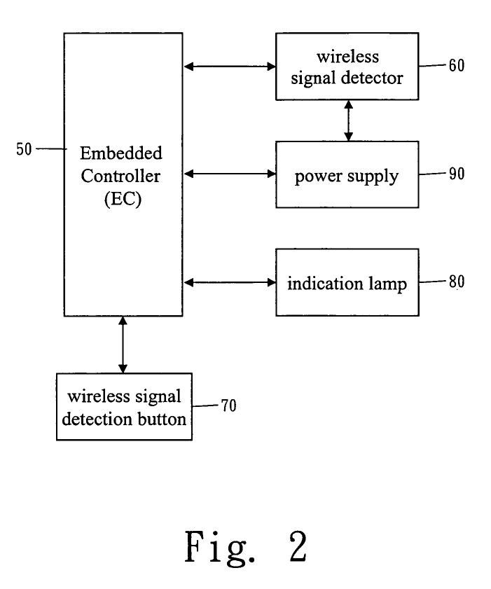

As shown in FIG. 2, the wireless signal detection button 70 and the embedded controller 50 are electrically connected; the wireless signal detector 60 and the input/output of the embedded controller 50 electronically connected; and the indication lamp 80 and the output of the embedded controller 50 is electronically connected. The wireless signal detector 60 and the indication lamp 80 can be activated via the output signal of the embedded controller 50. The wireless signal detector 60 and the embedded controller 50 are energized via a power supply 90.

When the portable electronic device 10 is in a shutdown state, pressing the wireless signal detection button 70 generates an input signal to the embedded controller 50. The control software (hereinafter referred to as the firmware) of the embedded controller 50 then follows the input signal of the wireless signal detection button 70 to activate the wireless signal detector 60 for detecting wireless signals. The location of the detection is checked to make sure whether it is inside the transmission range of the wireless local area network. The firmware of the embedded controller 50 further follows the detection result of the wireless signal detector 60 to determine whether a prompt of wireless networking should be given via the indication lamp 80.

With the wireless signal detection function of the portable electronic device 10 in a shutdown state, the user can access to the network wirelessly without the need of booting and shutting down the device repeatedly. The portable electronic device 10 of the present invention is time and energy saving with extended service life for the benefit of the user.

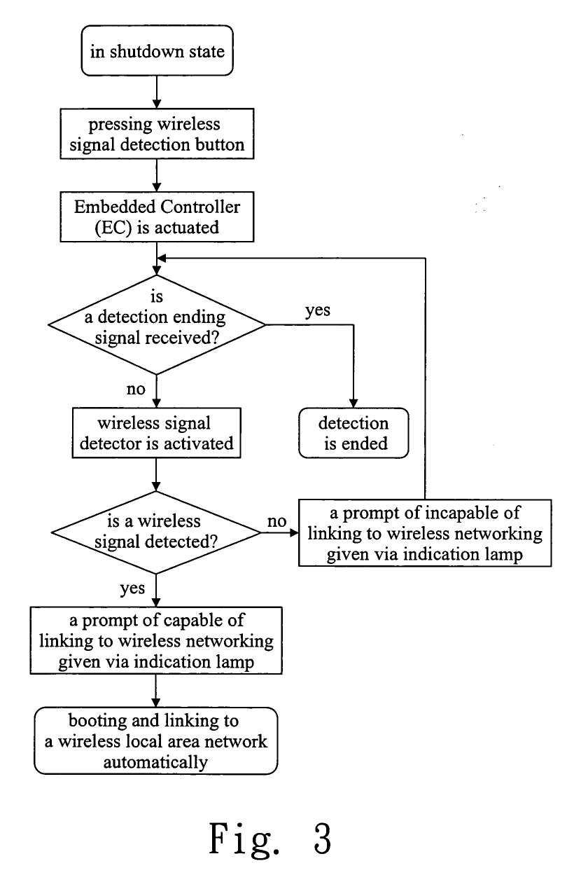

As shown in FIG. 3, when detecting a wireless signal in a shutdown state, the portable electronic device 10 boots and links to the wireless local area network automatically via the firmware of the embedded controller 50. The detection method comprises the following steps:
(a) Pressing the wireless signal detection button 70 generates an input signal to the embedded controller 50;
(b) Checking if a detection ending signal is received; if yes, executing Step (e); otherwise, the embedded controller 50 follows the input signal of Step (a) to activate the wireless signal detector 60 and start detecting wireless signals;
(c) Checking whether a wireless signal is detected; if yes, executing Step (d); otherwise, executing Step (b);
(d) The portable electronic device 10 boots and links to a wireless local area network automatically; and
(e) The detection ends.

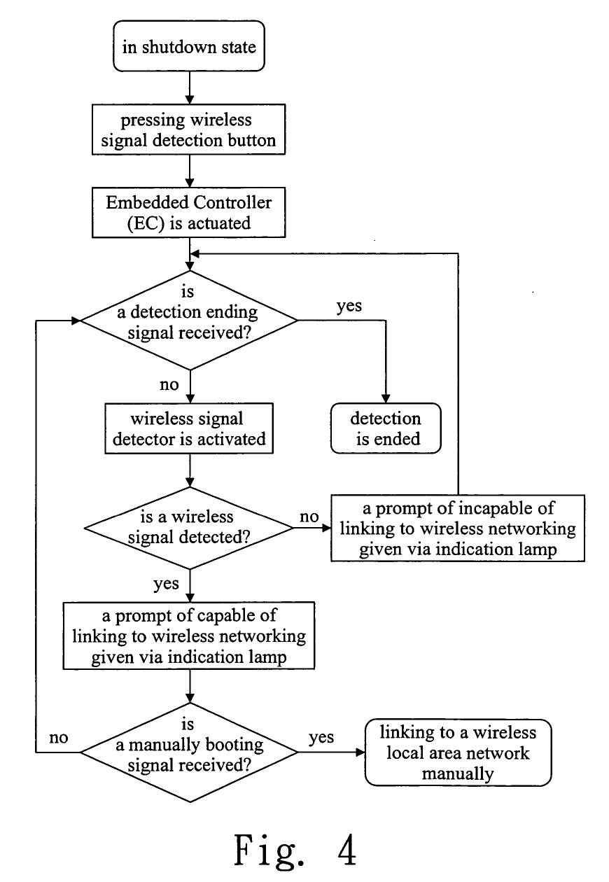

In FIG. 4, when detecting a wireless signal in a shutdown state, the portable electronic device 10 controls the indication lamp 80 via the firmware of the embedded controller 50 to give the user a prompt of booting the device and linking to a wireless local area network manually. The detection method comprises the following steps:
(a) Pressing the wireless signal detection button 70 generates an input signal to the embedded controller 50;
(b) Checking if a detection ending signal is received; if yes, executing Step (e); otherwise, the embedded controller 50 follows the input signal of Step (a) to activate the wireless signal detector 60 and start detecting wireless signals;
(c) Checking whether a wireless signal is detected; if yes, executing Step (d); otherwise, executing Step (b);
(d) Controlling the indicating lamp 80 to give the user a prompt of booting the device and linking to a wireless local area network manually; and
(e) The detection ends.

Although this invention has been disclosed and illustrated with reference to particular embodiments, the principles involved are applicable for use in numerous other embodiments that have equivalent effect, including modification, amendment, improvement, change, or use of an embedded controller (EC) to provide a portable electronic device with the wireless signal detection function in a shutdown state, and will be apparent to persons skilled in the art. This invention is, therefore, to be limited only as indicated by the scope of the appended claims.

What is claimed is:

1. A portable electronic device to detect wireless signals in a shutdown state, comprising a motherboard module with an internally embedded controller (EC) and a display module with a wireless signal detector; wherein an input/output of the wireless signal detector is electrically connected with the embedded controller; and a firmware of the embedded controller is followed an input signal to activate the wireless signal detector when the portable electronic device is in a shutdown state.

2. The portable electronic device as cited in claim 1, wherein the motherboard module has a wireless signal detection button connected to an input of the embedded controller to generate input signal to the embedded controller by way of pressing the wireless signal detection button.

3. The portable electronic device as cited in claim 1, wherein the motherboard module has an indication lamp connected to an output of the embedded controller and the operation of the indication lamp is under control of the embedded controller.

4. The portable electronic device as cited in claim 2, wherein the motherboard module has an indication lamp connected to an output of the embedded controller and the operation of the indication lamp is under control of the embedded controller.

5. The portable electronic device as cited in claim 1, wherein a method of detecting wireless signals in a shutdown state comprises the following steps:
(a) generating an input signal to the embedded controller;
(b) the embedded controller following the input signal of Step (a) to activate the wireless signal detector and start detecting wireless signals;
(c) checking whether a wireless signal is detected; if yes, executing Step (d); and
(d) the portable electronic device booting and linking to a wireless local area network automatically or giving users a prompt of booting the portable electronic device and linking to a wireless local area network manually via the indication lamp.
